(19) United States
(12) Patent Application Publication
(10) Pub. No.: US 2025/0269683 A1
(43) Pub. Date: Aug. 28, 2025

(54) WHEEL FASTENING SYSTEM

(71) Applicant: MCMURTRY AUTOMOTIVE LIMITED, Wotton-under-Edge Gloucestershire (GB)

(72) Inventors: George Karl SCHOLZ, Wotton-under-Edge Gloucestershire (GB); David Michael TURTON, Wotton-under-Edge Gloucestershire (GB)

(73) Assignee: MCMURTRY AUTOMOTIVE LIMITED, Wotton-under-Edge Gloucestershire, GB (GB)

(21) Appl. No.: 18/857,437

(22) PCT Filed: Apr. 28, 2023
(86) PCT No.: PCT/EP2023/061399

§ 371 Date: Oct. 16, 2024

(30) Foreign Application Priority Data
May 3, 2022 (GB) 2206435.6

(51) Int. Cl. B60B 3/16; F16B 39/32

(52) U.S. Cl. CPC B60B 3/16; F16B 39/32

(57) ABSTRACT

A wheel fastening system for a vehicle is disclosed. In an embodiment, a hub for mounting a wheel includes a threaded surface and a nut which is engageable with the threaded surface to fasten the wheel to the hub. When the nut is engaged with the threaded surface, rotation of the nut in a first direction about an axis of the hub results in tightening of the nut on the hub. A pawl assembly on one or more pawls and a ratchet which are arranged so that, when the nut is engaged with the threaded surface, each of the pawls engages with the ratchet to thereby allow rotation of the nut about the axis in the first direction and block rotation of the nut about the axis in a second, opposite direction. In this manner, unwanted loosening of the nut on the hub may be prevented.

### FIELD OF THE INVENTION

The present invention relates to a wheel fastening system for a vehicle, the system including a hub on which a wheel is mountable, and a nut for fastening the wheel onto the hub.

### BACKGROUND

A centrelock wheel is a type of vehicle wheel where the wheel is fastened to a wheel hub on the vehicle via a single, central fastening. Typically, a centrelock wheel is mounted on a central shaft of the hub. The shaft of the hub has a threaded surface, on which a nut can be engaged and tightened to clamp the wheel between the nut and hub. This centrelock arrangement is in contrast to the more common arrangement where the wheel is fastened to the hub via multiple (usually four or five) nuts or bolts arranged in a ring around a central axis of the wheel. Centrelock wheels are generally preferred in motorsport applications, as the use of a single nut for fastening the wheel to the hub facilitates rapid removal of the wheel, e.g. during a pitstop. The centrelock design also allows larger brakes to be used, and can provide increased wheel mounting strength. This may enable better handling of the large acceleration and braking torques, as well as lateral cornering forces which occur in motorsport applications.

However, a drawback of centrelock wheels is that the torque acting on the wheel during braking may act to undo the wheel nut. This is because it is conventional to arrange the threads on the nut and hub shaft such that accelerating forces and forward motion of the vehicle act to tighten the nut on the hub. Therefore, the nut of a centrelock wheel may loosen over time from braking of the vehicle, which may lead to loosening of the wheel on the hub and, in a worst case scenario, detachment of the nut and wheel from the hub. Accordingly, this issue is addressed by providing centrelock wheel systems with a mechanism for preventing the nut and wheel from falling off of (i.e. detaching from) the hub. For example, some centrelock systems include a pin in the hub which prevents the nut from falling off of the hub, to retain the nut on the hub in case of loosening of the nut.

### SUMMARY OF THE INVENTION

At its most general, the present invention provides a wheel fastening system for a vehicle, the system comprising a hub on which a wheel is mountable and a nut for fastening the wheel to the hub, the system being configured to prevent loosening of the nut on the hub. The wheel fastening system prevents loosening of the nut by means of a pawl and ratchet mechanism arranged on the hub and nut. Thus, in contrast to the conventional centrelock systems mentioned above which only prevent the nut and wheel from detaching from the hub, the system of the invention is designed to prevent loosening of the nut in the first place. Preventing the nut from loosening may improve a safety and handling of the vehicle by ensuring that the wheel remains tightly fastened to the hub during use of the vehicle.

In contrast, with conventional centrelock systems that do not prevent loosening of the nut, the wheel may become loose on the hub over time even though the wheel is prevented from fully detaching from the hub. This can give rise to multiple issues, including unpredictable and unstable handling of the vehicle when the nut becomes loose. Additionally, a loose wheel may exert higher cyclic bending loads on the hub (compared to when the wheel is tightly fastened), which may increase fatigue of the hub and increase a risk of damage or failure of the hub, which in severe cases can result in an accident. Due to the risk associated with wheel loosening with conventional centrelock wheels, it is common practice in motorsport applications to regularly inspect vehicle wheels to detect loosening of the wheels. Additionally, wheel hubs may need to be checked frequently for damage, e.g. caused by fatigue. The wheel fastening system of the invention may reduce a need for such frequent inspections and maintenance, as the risk of the nut loosening is lower, and damage and wear effects associated with loosening of the nut may be avoided.

According to a first aspect of the invention, there is provided a wheel fastening system for a vehicle, the wheel fastening system comprising: a hub on which a wheel is mountable, the hub comprising a threaded surface; a nut which is engageable with the threaded surface to fasten the wheel to the hub, wherein, when the nut is engaged with the threaded surface, rotation of the nut in a first direction about an axis of the hub results in tightening of the nut on the hub; a pawl assembly arranged on a first one of the hub and the nut, the pawl assembly comprising one or more pawls; and a ratchet arranged on a second one of the hub and the nut; wherein, when the nut is engaged with the threaded surface, each of the one or more pawls is configured to engage with the ratchet to thereby allow rotation of the nut about the axis in the first direction and block rotation of the nut about the axis in a second, opposite direction.

Thus, when the wheel is mounted on the hub, the nut may be engaged with the threaded surface on the hub to fasten the wheel to the hub. Engagement of the one or more pawls in the pawl assembly with the ratchet allows the nut to be rotated in the first direction so that the nut can be tightened. However, engagement of the one or more pawls with the ratchet prevents rotation of the nut in the opposite direction, such that loosening of the nut is prevented. Therefore, once the wheel is mounted on the hub and the nut tightened to fasten the wheel, loosening of the nut is prevented. This may ensure that the wheel remains securely fastened on the hub during use of the vehicle, preventing the wheel from becoming loose on the hub and avoiding issues with conventional centrelock systems noted above.

The wheel fastening system may be a centrelock wheel fastening system. In particular, the hub may be configured to receive a centrelock wheel, where the centrelock wheel is mountable on the hub via a centre hole of the wheel.

The hub may serve to connect the wheel to the vehicle. The hub may thus comprise any suitable interface for connecting the hub to a relevant part of the vehicle, such as an axle, suspension upright, and/or steering mechanism of the vehicle.

The hub may comprise a shaft for receiving the wheel. The shaft may be a central shaft, such that the wheel is centred on the hub when the wheel is received on the shaft. For example, the shaft may be configured to fit in a centre hole of the wheel (e.g. of a centrelock wheel). The threaded surface may be provided on the shaft, e.g. on a surface of the shaft. In this manner, when the wheel is received on the shaft, the nut may be engaged with the threaded surface to fasten the wheel to the hub.

The hub may comprise a plate (e.g. disc), which is configured to abut a surface on the wheel when the wheel is mounted on the hub. Thus, when the wheel is mounted on the hub (e.g. on the shaft of the hub) and the nut is tightened onto the hub, the wheel may be clamped between the nut and the plate. In other words, the plate may act as a reaction surface against which the wheel is secured when the wheel is fastened to the hub.

The hub may comprise one or more torque transfer elements configured to transfer a torque to the wheel when the wheel is fastened to the hub. The torque transfer elements on the hub may be configured to engage corresponding torque transfer elements on the wheel, to enable transfer of torque between the hub and the wheel. For example, the hub may comprise one or more pins that are configured to engage one or more corresponding holes in the wheel (or vice versa) when the wheel is fastened to the hub, to enable the transfer of torque. The one or more torque transfer elements of the hub may be provided on the plate mentioned above.

The nut is engageable with the threaded surface on the hub to fasten the wheel to the hub. Thus, the nut may include a threaded surface configured to engage (mate) with the threaded surface of the hub, such that the nut can be screwed on to the hub. For example, the nut may include a threaded inner surface.

When the nut is engaged with the threaded surface on the hub, rotation of the nut in the first direction about the axis of the hub causes tightening of the nut on the hub, whereas rotation of the nut in the second, opposite direction about the axis of the hub would cause loosening of the nut. For example, the first direction may correspond to a clockwise direction, whilst the second direction may correspond to an anti-clockwise direction (or vice versa). Herein, the axis of the hub may refer to a central axis of the hub, e.g. the axis of the hub may be centred about the shaft of the hub, and extend in a longitudinal direction of the shaft. Thus, the axis of the hub may correspond to an axis of rotation of the wheel when the wheel is mounted on the hub.

The nut and the threaded surface on the hub may be arranged such that the first direction of rotation is opposite to a direction of rotation of the wheel during forward motion of the vehicle. In this manner, torques exerted on the wheel during forward acceleration of the vehicle may cause a torque to be exerted on the nut in the first, tightening, direction. As a result, the wheel fastening system may maintain a tightness of the nut during acceleration of the vehicle, whilst loosening of the nut during braking is prevented.

The nut may comprise an engagement surface, which is configured to engage the wheel when the wheel is mounted on the hub and the nut is engaged with the threaded surface on the hub, in order to clamp the wheel to the hub as mentioned above.

One of the pawl assembly and the ratchet is located on the nut, whilst the other is located on the hub. For example, in some embodiments the pawl assembly may be disposed on the hub and the ratchet may be disposed on the nut, whilst in other embodiments the pawl assembly may be disposed on the nut and the ratchet may be disposed on the hub.

The pawl assembly includes one or more pawls, each of which is configured to engage the ratchet when the nut is engaged with the threaded surface on the hub. For example each of the one or more pawls may comprise a finger (i.e. tip portion) which is configured to engage the ratchet when the nut is engaged with the threaded surface. The pawl assembly may comprise a pawl housing, to which each of the one or more pawls are connected.

The ratchet may include a plurality of evenly spaced teeth (e.g. protrusions) which are disposed in a circular arrangement. The ratchet may be arranged such that, when the nut is engaged with the threaded surface on the hub, the circular arrangement of teeth in the ratchet is centred about the axis of the hub.

The one or more pawls and the ratchet are configured to allow rotation of the nut about the axis of the hub in the first direction, whilst blocking rotation of the nut about the axis of the hub in the second direction. Thus, the pawl assembly and the ratchet cooperate to allow rotation of the nut about the axis of the hub in the first direction, while preventing rotation of the nut about the axis of the hub in the second direction.

This may be achieved through the shapes and arrangement of the one or more pawls and the ratchet. For example, the one or more pawls may be configured to slidably engage (i.e. contact and slide over) teeth in the ratchet when the nut is rotated about the axis in the first direction. On the other hand, the one or more pawls may be arranged such that at least one of the pawls abuts a blocking surface in the ratchet (e.g. on one of the teeth) when the nut is rotated in the second direction about the axis, to thereby block further rotation of the nut in the second direction. In order to enable the one or more pawls to slide over teeth in the ratchet when the nut is rotated in the first direction, the one or more pawls may be movably mounted in the pawl housing, to enable relative movement between each of the pawls and the pawl housing as the pawls slide over the teeth. For example, the one or more pawls may be movable relative to the pawl housing in a radial direction, or the one or more pawls may be pivotably connected to the pawl housing.

As noted above, in some embodiments, the pawl assembly may be disposed on the hub, and the ratchet may be disposed on the nut. The ratchet may be a part of the fastening system which is susceptible to wear and damage, e.g. because teeth of the ratchet may become worn or damaged over time. Thus, if the ratchet becomes worn or damaged, then the nut can be replaced, without having to replace other parts of the system. In this manner, maintenance of the fastening system may be facilitated. On the other hand, if the ratchet is provided on the hub, then it may be necessary to replace the entire hub if the ratchet becomes worn or damaged, which may be a much more complicated and time-consuming process compared with simply replacing the nut. Arranging the pawl assembly on the hub and the ratchet on the nut may also simplify a construction of the nut, as this may avoid having to include any moving parts (e.g. the one or more pawls) in the nut. Any moving parts of the system may instead be housed in the hub, which may have more room for such parts.

When the pawl assembly is disposed on the hub and the ratchet is disposed on the nut, the one or more pawls may be arranged to extend outwards (e.g. radially outwards) from the axis of the hub. In this manner, when the nut is engaged on the threaded surface of the hub, centrifugal forces resulting from rotation of the wheel may urge the one or more pawls outwards from the axis of the hub and into engagement with the ratchet. In particular, each of the one or more pawls may be configured to engage the ratchet with a portion (e.g. finger) of the pawl which is located furthest from the axis of the hub. As a result, the engagement between the one or more pawls and the ratchet may be strengthened.

Each of the one or more pawls may be configured to protrude through an aperture in the hub to engage with the ratchet. Thus, at least part of the pawl assembly may be contained within the hub. For example, the shaft of the hub may be hollow, and part of the pawl assembly may be contained within the hollow shaft. The hollow shaft may have one or more apertures, through which the one or more pawls are configured to protrude, respectively. In this manner, the pawl assembly may be protected within the hub, with only parts of the one or more pawls protruding from the hub in order to engage the ratchet on the nut. In particular, any mechanisms of the pawl assembly which enable relative movement of the one or more pawls (such as springs and/or movable connections between the pawls and pawl housing) may be contained within the hub. Where each of the one or more pawls includes a finger for engaging the ratchet, as mentioned above, then the finger of each of the one or more pawls may be configured to protrude through the aperture in the hub to engage with the ratchet.

In some embodiments, the pawl assembly may comprise two or more pawls. Using multiple pawls may serve to increase a strength of the engagement between the ratchet and the pawl assembly when the nut is engaged with the threaded surface on the hub, thus reducing a risk of slippage between the pawls and the ratchet in the second direction. Accordingly, a risk of the nut coming loose from the hub may be reduced. Additionally, providing multiple pawls may serve to reduce a stress experienced by teeth of the ratchet and by each individual pawl. Thus, a longevity of the ratchet and the pawl assembly may be improved. Furthermore, using two or more pawls may enable the pawl assembly to still block rotation of the nut in the second direction, even if there is a failure with one of the pawls.

The two or more pawls may comprise a pair of pawls which are arranged to extend radially relative to the axis of the hub when the nut is engaged with the threaded surface on the hub. In this manner, the pair of pawls may engage the ratchet at different radial locations about the axis of the hub. This may improve a strength of engagement between the pawl assembly and the ratchet, to improve an effectiveness with which rotation of the nut in the second direction is blocked.

Herein, a pawl extending radially relative to the axis of the hub may mean that the pawl extends in a direction that intersects the axis of the hub. For example, the pawl may extend in a direction normal to the axis of the hub.

The pair of pawls may be arranged to extend in opposite directions relative to the axis of the hub when the nut is engaged with the threaded surface on the hub. Thus, the pair of pawls may engage the ratchet at opposite locations with respect to the axis of the hub. As a result forces experienced by the ratchet when a torque is applied to the nut may be more evenly distributed about the axis of the hub, which may reduce a risk of tooth failure and a risk of slippage between the ratchet and the pawls in the second direction. In particular, both pawls in the pair of pawls may simultaneously engage respective teeth in the ratchet, in order to block rotation of the nut in the second direction. This may improve a strength and reliability with which rotation of the nut in the second direction can be blocked. As an example, the pair of pawls may include a first pawl and a second pawl extending in radially opposite directions relative to the axis of the hub. Then, if a torque is applied to the nut in the second direction, the first pawl and the second pawl may experience respective forces from the ratchet acting in opposing directions. In this manner, forces acting on the pair of pawls may be substantially evenly split between the first and the second pawl, thus reducing stresses experienced by the pawls, the teeth of the ratchet, and the hub. Where the pawl assembly includes a pawl housing, this may also serve to reduce stresses experienced by the pawl housing.

The pawl assembly may include multiple (e.g. two or more) pairs of pawls, where the pawls in each pair are arranged to extend in radially opposite directions relative to the axis of the hub when the nut is engaged with the threaded surface on the hub. This may serve to further strengthen engagement between the pawl assembly and the ratchet, and distribute forces from the ratchet around the pawl assembly. This may also serve to ensure that the pair of pawls can simultaneously engage teeth in the ratchet to block rotation of the nut in the second direction, thus reducing a risk of slippage between the pawls and the ratchet in the second direction.

The pair of pawls may be arranged to extend away from the axis of the hub when the nut is engaged with the threaded surface on the hub. In other words, each pawl in the pair may be configured to engage the ratchet via a portion (e.g. finger) which is located furthest from the axis of the hub. In line with the discussion above, this may result the pair of pawls being urged outwards from the axis in response to centrifugal forces caused by rotation of the wheel, such that the pair of pawls may be urged into engagement with the ratchet in response to the centrifugal forces.

In some embodiments, the ratchet may comprise a plurality of evenly spaced teeth disposed in a circular arrangement; and the two or more pawls may comprise a first pawl and a second pawl, the first pawl and the second pawl being arranged such that a first angular spacing between adjacent teeth in the ratchet is not a factor of a second angular spacing between the first pawl and the second pawl, the first angular spacing and the second angular spacing being relative to a circle centred at the axis of the hub when the nut is engaged with the threaded surface on the hub. Thus, in such an embodiment, the second angular spacing between the first and second pawls is not a multiple of the first angular spacing between adjacent teeth in the ratchet. This arrangement may serve to reduce an amount by which the nut can be loosened in the second direction, if a slippage does occur between one of the pawls and the ratchet (e.g. because of failure of one of the pawls and/or one of the teeth in the ratchet). In particular, when the first pawl is engaged with one of the teeth in the ratchet in a manner that blocks rotation of the nut in the second direction, the second pawl may not be blockingly engaged with any of the teeth in the ratchet, i.e. the second pawl may be engaged with the ratchet at a location between adjacent teeth. This is because, as the angular spacing between the teeth is not a factor of the angular spacing between the first and second pawls, only one of the first and second pawls at a time can be fully engaged with a tooth in the ratchet in a manner that blocks rotation of the nut in the second direction. As a result, if the engagement between the first pawl and the ratchet slips (e.g. because of failure of the first pawl and/or the tooth engaged with the first pawl), then the nut may only rotate in the second direction by an amount less than the first angular spacing between the teeth of the ratchet, until the second pawl comes into engagement with one of the teeth of the ratchet to block further rotation in the second direction. Thus, this arrangement of the first and second angular spacings may ensure that the nut can only be loosened by an amount less than the first angular spacing, in case of a failure of one of the pawls and/or one or more teeth of the ratchet. In contrast, if the first angle were a factor of the second angle, then both the first and second pawls could simultaneously engage a tooth of the ratchet to block rotation in the second direction. However, if a slippage between the pawls and the ratchet were to occur, then the nut could rotate by the full amount of the first angular spacing, i.e. until the pawls engage the next teeth in the ratchet, which may represent an undesirably large amount of loosening.

Additionally, this arrangement of the first and second angular spacings may serve to reduce an amount of backlash (or play) that is present once the nut has been tightened onto the hub. This is because, once the nut is screwed onto the hub, it can at most be loosened by an amount less than the first angular spacing between the teeth of the ratchet before one of the pawls engages a tooth in the ratchet to block further rotation in the second direction. For example, if when the nut is tightened onto the hub neither of the first and second pawls fully engages a tooth of the ratchet, then the nut may settle back to a position where one of the first and second pawls abuts a tooth in the ratchet to block further rotation in the second direction. Such a settling rotation will have an angle less than the first angular spacing between the teeth of the ratchet, such that the nut may maintain a closer tightness to an amount to which it was tightened. Thus, where a specified torque is used to tighten the nut, the nut may maintain a closer tightness to its specification. Accordingly, safety of the system may be improved, and fatigue on parts of the system may be reduced.

The first and second pawl mentioned above may be part of a first pair of pawls and a second pair of pawls, respectively. The first and second pair of pawls may be arranged in the manner discussed above for pairs of pawls. For example, the first pair of pawls may include two pawls which extend in radially opposite directions relative to the axis of the hub, whilst the second pair of pawls may include two further pawls which extend in radially opposite directions relative to the axis of the hub. Then, the angular spacing between the first pawl in the first pair and the first pawl in the second pair (i.e. the second angular spacing) may be arranged such that it is not a multiple of the first angular spacing between adjacent teeth in the ratchet.

The first angular spacing and the second angular spacing mentioned above are taken relative to a circle centred at the axis of the hub. In other words, the first and second angular spacing correspond to an angle swept by a radius originating from the axis of the hub and located in a plane normal to the axis of the hub (i.e. in a plane of rotation of the nut relative to the hub when the nut is engaged with the threaded surface on the hub).

The pawl assembly may further comprise a biasing element configured to urge the one or more pawls into engagement with the ratchet when the nut is engaged with the threaded surface on the hub. This may ensure that the one or more pawls engage the ratchet and remain in contact with the ratchet when the nut is screwed on to the hub. As a result, a risk of slippage between the pawls and the ratchet may be reduced. The biasing element may be implemented using any suitable elastic (i.e. resilient) element, such as a spring. The pawl assembly may comprise a respective biasing element for each of the one or more pawls, such that each of the one or more pawls may be urged into engagement with the ratchet by its respective biasing element.

As an example, where the one or more pawls extend outwards from the axis of the hub, the biasing element may be configured to urge the one or more pawls outwards from the axis of the hub to engage the ratchet when the nut is engaged with the threaded surface on the hub. Where each of the one or more pawls is configured to protrude though an aperture in the hub to engage the ratchet, the biasing element may be configured to urge the one or more pawls to protrude from the aperture in the hub. The pawl assembly may be configured to retain the one or more pawls, e.g. so that they are not ejected from the pawl assembly by the biasing element. For example, the aperture may be shaped so that only a finger (i.e. end portion) of each pawl can protrude from the aperture.

The pawl assembly may further comprise a pawl housing; and each of the one or more pawls may be received in a respective channel formed in the pawl housing, the channel being configured to guide movement of the pawl in a radial direction relative to the axis of the hub when the nut is rotated about the axis of the hub. Thus, the pawl housing may serve to guide motion of the pawls when they are engaged with the ratchet. When the nut is rotated in the first direction to tighten it, the pawls may slide over teeth in the ratchet as mentioned above, which may cause radial movement of the pawls. In particular, as a pawl slides over the ratchet teeth, it may move in a radial direction (i.e. towards and away from the axis of the hub) due to the profile of the teeth. The channels in the pawl housing may serve to ensure that a correct placement of the pawls is maintained, and that the pawls are not knocked out of engagement with the ratchet. In particular, the channels may serve to ensure that the pawls are maintained in place in engagement with the ratchet when a torque is applied to the nut in the second direction. This arrangement may also enable the pawl housing to absorb some of the stresses experienced by the pawls when a torque is applied to the nut in the second direction, increasing a strength with which rotation of the nut in the second direction can be blocked.

Each pawl may be movably mounted within its respective channel, so that it can move relative to the pawl housing along (i.e. backwards and forwards along) its respective channel. Each pawl may be movably mounted within its respective channel, such that it is movable between an extended state in which the pawl protrudes from the channel, and a retracted state in which it does not protrude (or protrudes to a lesser extent) from the channel. Thus, in the extended state, the pawl can engage the ratchet, whilst in the retracted state it can be disengaged from the ratchet.

Each respective channel may be configured to limit motion of the pawl to motion along the channel. For instance, each pawl may have a cross-sectional shape that substantially matches a cross-sectional shape of its respective channel, such that the pawl can slide along the channel but cannot move laterally relative to the channel.

Each respective channel in the pawl housing may be arranged such that it extends in a radial direction with respect to the axis of the hub when the nut is engaged with the threaded surface on the hub. In this manner, motion of the pawls relative to the housing may be limited to a radial direction with respect to the axis of the hub.

Where the pawl assembly includes a biasing element as mentioned above, the biasing element for each of the one or more pawls may be located in the respective channel, and connected between the pawl housing and the pawl.

Each respective channel may be configured to limit motion of the pawl along the channel between its extended state and its retracted state, e.g. such that the pawl is prevented from being moved beyond its extended and retracted states. This may prevent the pawl from falling out of its channel, and/or being ejected from its channel by the biasing element. As an example, each pawl may comprise a body portion located within the channel, and a finger which is configured to protrude through an aperture at an end of the channel when the pawl is in the extended state. The body portion of the pawl may be larger than the aperture, such that the body portion is prevented from exiting the channel via the aperture. In this manner, the pawl may not fall out of the channel.

Where the pawl assembly is disposed on the hub, the pawl housing may be mounted in the hub. In some cases, the pawl housing may be integrally formed as part of the hub. Alternatively, the pawl housing may be formed as a separate component which is connected to the hub.

As an example, the pawl housing may be mounted in the shaft of the hub. Where the pawl housing includes respective channels for the one or more pawls as mentioned above, each respective channel may be aligned with an aperture in the hub so that the corresponding pawl can protrude from the aperture to engage the ratchet.

The pawl housing may comprise a rotational locking feature that is engaged with a corresponding rotational locking feature on the hub, such that the pawl housing and hub are configured to rotate together about the axis of the hub. This may serve to avoid slippages between the pawl housing and the hub, and prevent the nut from being rotated in the second direction. As an example, a splined connection may be provided between the pawl housing and the hub, which may provide strong rotational locking between these two parts. For instance, the rotational locking feature on the pawl housing may comprising a male spline and the rotational locking feature on the hub may comprise a female spline (or vice versa).

Each of the one or more pawls may be configured to be disengageable from the ratchet when the nut is engaged with the threaded surface on the hub. In other words, when the nut is engaged with the threaded surface on the hub such that the one or more pawls engage the ratchet, the one or more pawls may be moved to disengage them from the ratchet. In this manner, the one or more pawls can be disengaged from the ratchet to allow rotation of the nut in the second direction, so that the nut can be removed from the hub, e.g. to remove and/or replace the wheel.

Each of the one or more pawls may include a ratchet engaging portion configured to engage the ratchet, and a tool receiving portion configured to receive a disengaging force from a tool, the pawl being configured to disengage from the ratchet in response to application of the disengaging force to the tool receiving portion. In this manner, by applying the disengaging force to the tool receiving portion on each of the one or more pawls with the tool, the one or more pawls may be disengaged from the ratchet to allow rotation of the nut in the second direction, so that the nut can be removed from the hub. This may facilitate removing the nut from the hub, e.g. to remove and/or replace the wheel.

The ratchet engaging portion of a pawl may correspond to the ‘finger’ portion of the pawl mentioned above. The ratchet engaging portion of the pawl may comprise a surface which is configured to engage (i.e. contact) the ratchet when the nut is engaged with the threaded surface on the hub. The tool receiving portion of a pawl may comprise a surface for receiving the disengaging force from the tool. The tool receiving portion of the pawl may be arranged such that it is accessible (e.g. visible) when the nut is engaged with the threaded surface on the hub, so that the tool can be engaged with the tool receiving portion to apply the disengaging force. For example, the tool receiving portion may be arranged such that it is exposed on an outside of the wheel fastening system when the nut is engaged on the threaded surface of the hub, to make it easily accessible.

The tool used for applying the disengaging force may be configured (i.e. shaped) to apply the disengaging force to the tool receiving portion of each of the one or more pawls simultaneously, to facilitate removal of the nut from the hub. For example, the tool may include one or more engagement portions which are arranged to simultaneously contact the tool receiving portions of the one or more pawls. Then, to remove the nut from the hub, the tool may be brought into contact with the pawl assembly, such that a disengaging force is applied to each of the one or more pawls, causing the one or more pawls to disengage from the ratchet. While maintaining the disengaging force on the one or more pawls, the nut can then be rotated in the second direction to remove it from the hub. The tool may form part of the wheel fastening system of the invention.

The tool receiving portion of each of the one or more pawls may comprise a slanted surface that slants towards the axis of the hub; and the pawl may be configured to move radially relative to the axis of the hub in response to a disengaging force applied to the slanted surface along a direction parallel to the axis of the hub. The slanting of the slanted surface towards the axis of the hub enables a disengaging force applied in a longitudinal direction (i.e. parallel to the axis of the hub) to the slanted surface to be converted into a radial movement of the pawl relative to the axis of the hub. In other words, by applying a disengaging force parallel to the axis of the hub, the pawl can be moved in a direction normal to the axis of the hub. The radial motion of the pawl relative to the axis of the hub may cause the pawl to be disengaged from the ratchet, so that it does not block rotation of the nut in the second direction. Accordingly, this arrangement may facilitate removing the nut from the hub, as a user can easily disengage the one or more pawls from the ratchet by applying a longitudinal disengaging force to the tool receiving portion of the one or more pawls. Herein, the slanted surface slanting towards the axis of the hub may mean that the slanted surface extends in a direction that intersects the axis of the hub.

The ratchet may comprise a plurality of evenly spaced teeth disposed in a circular arrangement, each tooth of the ratchet having a first tooth surface and a second tooth surface; each of the one or more pawls may have a first pawl surface that is configured to contact and slide over the first tooth surface of one of the teeth when the nut is engaged with the threaded surface and the nut is rotated about the axis of the hub in the first direction; each of the one or more pawls may have a second pawl surface that is engageable with the second tooth surface of one of the teeth when the nut is engaged with the threaded surface, whereby engagement of the second pawl surface of one of the one or more pawls with the second tooth surface of one of the teeth blocks rotation of the nut about the axis of the hub in the second direction. In other words, the teeth in the ratchet and the one or more pawls have surfaces that are shaped to allow rotation of the nut in the first direction, whilst blocking rotation of the nut in the second direction. In particular, whilst the first pawl surface can slide over the first tooth surface when the nut is rotated in the first direction, when the nut is rotated in the second direction the second pawl surface of one of the one or more pawls engages the second tooth surface of one of the ratchet teeth, preventing rotation of the nut in the second direction.

For each tooth of the ratchet, the first tooth surface and the second tooth surface may be shaped such that the tooth is asymmetrical about a radius of the circular arrangement extending through a tip of the tooth. In other words, for a given tooth in the ratchet, its first tooth surface and second tooth surface may be asymmetrical about a radius linking a centre of the circular arrangement of teeth and a tip of that tooth. Such an asymmetrical shape of the teeth in the ratchet may enable different types of engagement between the one or more pawls and the ratchet, depending on in which direction the nut is rotated, so that rotation of the nut in the first direction is allowed whilst rotation of the nut in the second direction is blocked. For example, the first tooth surface and the second tooth surface may have different shapes (e.g. profiles), giving rise to the asymmetry of the tooth. The tip of the tooth may correspond to a part of the tooth that protrudes furthest from a base of the ratchet.

For each tooth of the ratchet, the second tooth surface may be aligned along a respective radial direction of the circular arrangement, and the first tooth surface may be slanted relative to the respective radial direction. Thus, for a given tooth in the ratchet, the second tooth surface may be substantially aligned with a radius linking a centre of the circular arrangement of ratchet teeth and a tip of that tooth. As a result, the second tooth surface may be substantially normal to a direction of rotation of the nut when the nut is engaged on the threaded surface of the hub. This may ensure that the second tooth surface can effectively block rotation of the nut in the second direction when it is engaged by one of the one or more pawls, as this orientation of the second tooth surface may prevent the pawl from sliding over the tooth. This orientation of the second tooth surface may also reduce a risk of slippage between the pawl and the ratchet. On the other hand, the slanting of the first tooth surface relative to the radial direction for the tooth may enable a pawl to slide over the first tooth surface when the nut is engaged on the threaded surface of the hub and rotated in the first direction.

Each tooth may have a rounded or smooth edge, located at an interface between the first tooth surface and the second tooth surface. In other words, the tip of the tooth may have a rounded or smooth edge. This may serve to avoid reduce wear on the teeth and pawls, whilst minimising a risk of slippage in the second direction when a pawl is engaged with the second tooth surface.

Each of the one or more pawls may be arranged to extend along a respective radial axis that is normal to the axis of the hub when the nut is engaged with the threaded surface; and for each of the one or more pawls, the first pawl surface and the second pawl surface may be shaped such that the pawl is asymmetrical about its respective radial axis. In other words, for a given pawl, its first pawl surface and second pawl surface may be asymmetrical about a radial axis intersecting the axis of the hub in a normal direction when the nut is engaged with the threaded surface on the hub. Such an asymmetrical shape of the one or more pawls may enable different types of engagement between the one or more pawls and the ratchet, depending on in which direction the nut is rotated, so that rotation of the nut in the first direction is allowed whilst rotation of the nut in the second direction is blocked. For example, the first pawl surface and the second pawl surface may have different shapes (e.g. profiles), giving rise to the asymmetry of the pawl.

The first pawl surface of each of the one or more pawls may be aligned parallel to its respective radial axis, and the second pawl surface of each of the one or more pawls may slanted relative to its respective radial axis. The shapes of the first pawl surface and of the second pawl surface may provide similar functions to the first tooth surface and the second tooth surface discussed above. In particular, the first pawl surface being aligned parallel to the respective radial axis may result in the first pawl surface being substantially normal to a direction of rotation of the nut when the nut is engaged with the threaded surface on the hub.

This may prevent the pawl from sliding over a tooth in the ratchet when a torque is applied to the nut in the second direction, such that rotation of the nut in the second direction is effectively blocked. This orientation of the second pawl surface may also reduce a risk of slippage between the pawl and the ratchet. On the other hand, the slanted first pawl surface may facilitate the pawl sliding over the ratchet teeth when the nut is rotated in the first direction.

Each pawl may have a rounded or smooth edge, located at an interface between the first pawl surface and the second pawl surface. The rounded or smooth edge on the pawl may serve to reduce wear on the pawl and teeth, whilst minimising a risk of slippage in the second direction when the pawl is engaged with a tooth in the ratchet.

The nut may comprise an outer face having a plurality of tool engagement features arranged around a central axis of the nut for applying a torque to the nut about its central axis. This may enable the nut to be engaged by a tool, so that a torque (e.g. in the first direction or the second direction) can be applied to the nut. The outer face of the nut may be a face of the nut which is arranged to face outwards (i.e. away from the hub) when the nut is engaged with the threaded surface on the hub. As a result, the outer face of the nut may be easily accessible when it is used to fasten a wheel to the hub, so that a user can use the tool engagement features on the nut to apply a torque to the nut. This may facilitate applying large torques to the nut so that the nut can be reliably tightened on the hub. This may also facilitate unscrewing the nut from the hub, e.g. when the one or more pawls are disengaged from the ratchet as discussed above.

The tool engagement features may comprise any suitable features to enable application of a torque to the nut. In some cases, the one or more tool engagement features may be disposed in a circular array around a central hole of the nut, which may facilitate application of a torque to the nut about the axis of the hub when nut is engaged with the threaded surface on the hub, e.g. to tighten or loosen the nut. As an example, the tool engagement features may comprise one or more apertures in the outer face, e.g. so that a tool can be inserted into the one or more apertures to thereby apply a torque to the nut. As another example, the tool engagement features may comprise one or more protrusions in the outer face, e.g. so that the one or more engagement features can be received in corresponding cavities or apertures of the tool, to thereby enable application of a torque to the nut.

Additionally or alternatively, the nut may comprise tool engagement features in the form of one or more flat edges located on a periphery (e.g. side surface) of the nut, to facilitate gripping the outer face with a tool to thereby apply a torque to the nut.

The wheel fastening system of the first aspect of the invention may form part of a vehicle according to a second aspect of the invention. Thus, according to a second aspect of the invention, there is provided a vehicle comprising a wheel fastening system according to the first aspect of the invention. Any of the features discussed above in relation to the first aspect of the invention may be shared with the second aspect of the invention.

The wheel fastening system may be arranged to fasten a wheel to the vehicle. A respective wheel fastening system may be provided for each wheel of the vehicle.

The vehicle may be any type of vehicle, such as a car (e.g. a road car or a race car), an off-road vehicle, or a truck.

### BRIEF DESCRIPTION OF THE DRAWINGS

Embodiments of the invention are discussed below with reference to the accompanying drawings, in which:

FIG. 1 is a schematic cross-sectional side view of a wheel fastening system according to an embodiment of the invention;

FIG. 2a is a schematic diagram of an external-facing side of a nut that is part of the wheel fastening system of FIG. 1;

FIG. 2b is a schematic diagram of a wheel-facing side of the nut of FIG. 2a;

FIG. 2c is a schematic cross-sectional diagram of the nut of FIG. 2a;

FIG. 3a is a schematic cross-sectional side view of a pawl assembly of the wheel fastening system of FIG. 1;

FIG. 3b is a schematic cross-sectional front view of the pawl assembly of the wheel fastening system of FIG. 1;

FIG. 4a is a schematic side view of a pawl of the pawl assembly of the wheel fastening system of FIG. 1;

FIG. 4b is a schematic top view of the pawl of FIG. 4a;

FIG. 4c is a schematic cross-sectional front view of the pawl of FIG. 4a;

FIG. 5 is a schematic diagram showing an expanded view of a portion of the external-facing side of the nut of FIG. 2a;

FIG. 6 is a schematic cross-sectional side view of the wheel fastening system of FIG. 1;

FIG. 7a is a schematic cross-sectional front view of the wheel fastening system of FIG. 1, where the nut is in a first rotational position; and

FIG. 7b is a schematic cross-sectional front view of the wheel fastening system of FIG. 1, where the nut is in a second rotational position.

### DETAILED DESCRIPTION; FURTHER OPTIONAL FEATURES

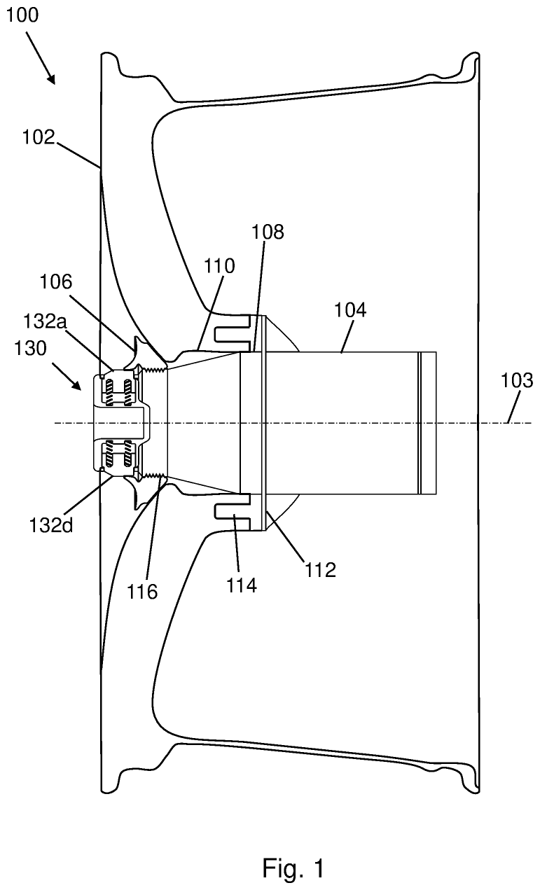

FIG. 1 shows a cross-sectional view of a wheel fastening system 100 according to an embodiment of the invention. The wheel fastening system 100 is configured to fasten a wheel 102 to a vehicle (not shown). The wheel fastening system 100 is a centrelock fastening system, as the wheel 102 is fastened to a hub 104 using a single central nut 106. The wheel fastening system 100 is configured to prevent loosening of the nut 106 once the nut has been screwed onto the hub 104, to ensure that the wheel 102 remains tightly fastened to the hub 104 during use of the vehicle. The cross-sectional view of FIG. 1 is taken in a plane that includes a central axis 103 of the hub 104. The central axis 103 of the hub 104 corresponds to an axis of rotation of the wheel 102 when the wheel 102 is mounted on the hub 104. For illustration purposes, no tire is shown on the wheel 102 in FIG. 1.

The wheel fastening system 100 includes the hub 104, on which the wheel 102 is mountable. In particular, the hub 104 includes a central shaft 108 which is configured to receive a centre hole 110 of the wheel 102. An outer diameter of the central shaft 108 may substantially match a diameter of the centre hole 110 of the wheel 102, so that the wheel 102 can be mounted onto the central shaft 108. The hub 104 further includes a plate 112 against which the wheel 102 is clamped when the wheel 102 is mounted on the hub 104. The plate 112 includes a series of pins 114 which are configured to be received in corresponding apertures or channels in the wheel 102 when the wheel 102 is mounted on the hub 104, to enable transmission of torque from the hub 104 to the wheel 102.

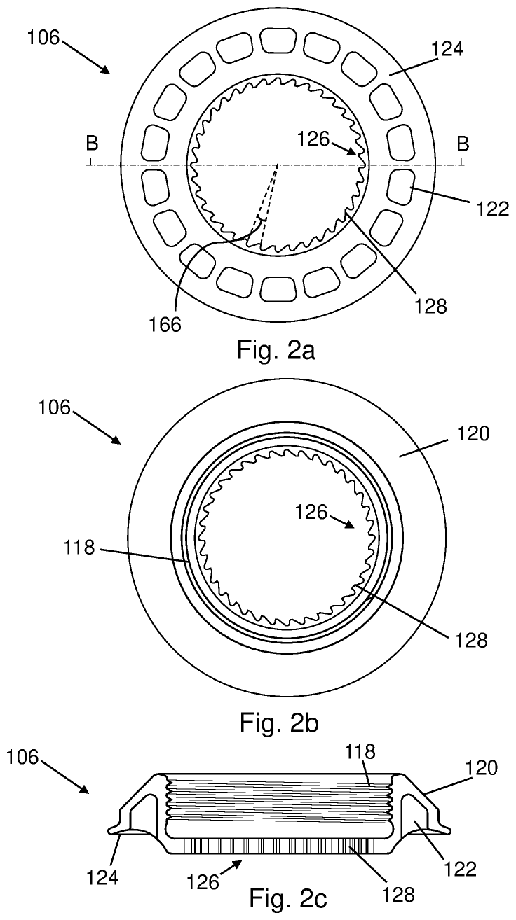

The nut 106 is illustrated in FIGS. 2a-2c, which show different views of the nut 106. In particular, FIG. 2a shows a view of an external-facing side of the nut 106, FIG. 2b shows a view of a wheel-facing side of the nut 106, and FIG. 2c shows a cross-sectional side view of the nut 106. The cross-sectional view of FIG. 2c is taken along the plane B-B shown in FIG. 2a. In use, the wheel-facing side of the nut 106 faces towards a wheel mounted on the hub 104 (e.g. wheel 102), whilst the external-facing side of the nut 106 faces away from the wheel (e.g. towards an outside of the vehicle). The nut 106 is engageable with a threaded surface 116 provided on an outer surface of the central shaft 108, such that the nut 106 can be screwed on to the central shaft 108. In particular, the nut 106 includes a central hole having a threaded inner surface 118 which is configured to engage (i.e. mate with) the threaded surface 116 on the central shaft 108. The nut 106 further includes a clamping surface 120 located on its wheel-facing side, the clamping surface 120 being configured to abut a surface on the wheel 102 located around its centre hole 110. In this manner, when the wheel 102 is mounted on the central shaft 108 and the nut 106 is screwed onto the threaded surface 116, the clamping surface 120 abuts the wheel 102. The nut 106 can then be tightened, in order to clamp the wheel 102 between the nut 106 and the plate 112, so that the wheel is securely held on the hub 104, as shown in FIG. 1. The clamping surface 120 of the nut 106 may be slanted relative to the central axis 103 of the hub 104, so that it can act as a wedge against the corresponding surface on the wheel 102 around its centre hole 110 to firmly hold the wheel 102 in place on the central shaft 108. In the embodiment shown, the nut also includes engagement features in the form of a plurality of apertures (or channels) 122 formed on an outer face 124 on the external-facing side of the nut 106. The plurality of apertures 122 are disposed in a circular arrangement around the central hole of the nut 106. The plurality of apertures 122 may facilitate applying a torque to the nut 106 by engaging a tool in the apertures 122, e.g. to screw the nut 106 onto the hub 104. Other types of engagement features may be provided on the external-facing side of the nut 106 to facilitate applying a torque to the nut 106, such as protrusions in the outer face 124, and/or flat edges around a periphery of the nut 106.

The nut 106 further includes a ratchet 126 arranged on its external-facing side. The ratchet 126 includes a plurality of evenly spaced teeth 128 disposed in a circular arrangement. The circular arrangement of teeth 128 is centred about the central hole of the nut 106, such that the circular arrangement of teeth 128 is centred about the axis 103 of the hub 104 when the nut 106 is screwed onto the threaded surface 116 of the hub 104. Each tooth 128 of the ratchet 126 is a protrusion which protrudes from an edge of the outer face 124 of the nut 106 towards a centre of the circular arrangement. Each tooth 128 in the ratchet 126 has substantially the same shape.

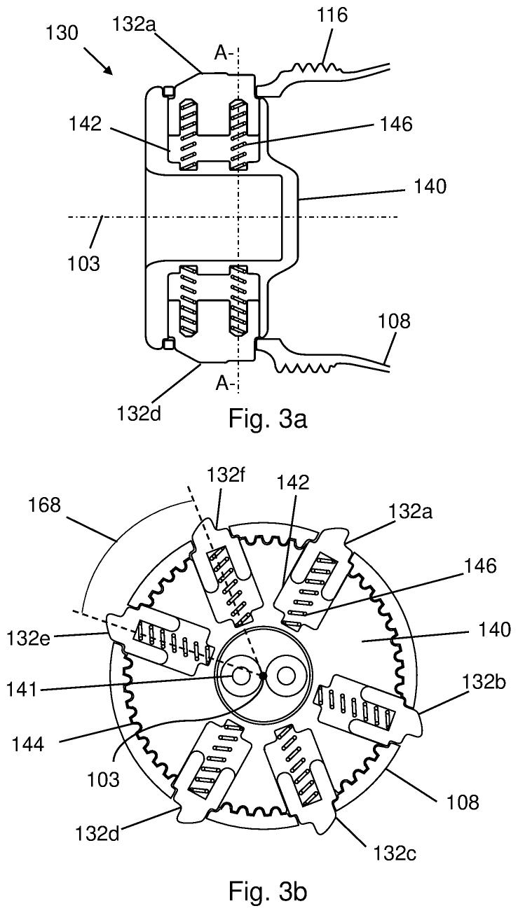

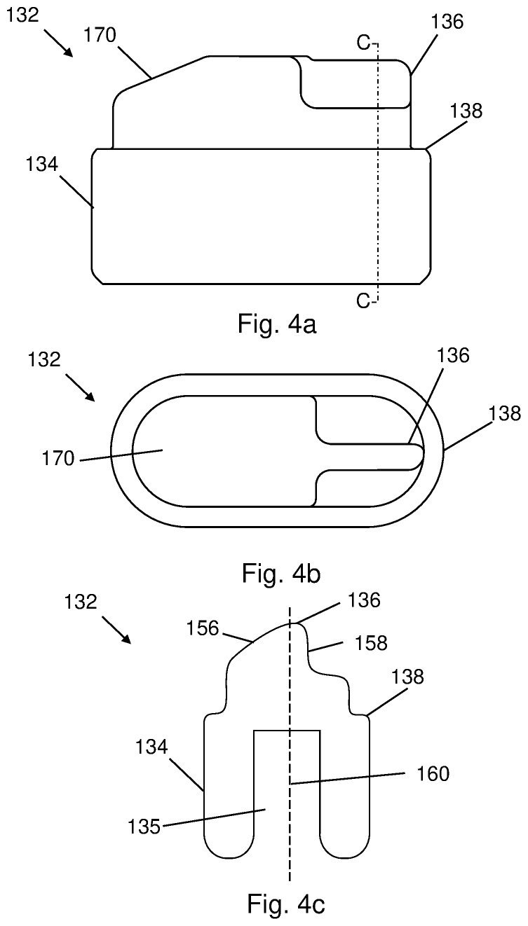

The ratchet 126 is configured to cooperate with a pawl assembly 130 on the hub 104, to allow rotation of the nut 106 in a first direction to tighten the nut 106 on the hub 104, but to prevent rotation of the nut 106 in a second, loosening direction. The pawl assembly 130 is illustrated in FIGS. 3a-3b, with FIG. 3a showing a side cross-sectional view of the pawl assembly 130 and FIG. 3b showing a cross-sectional front view of the pawl assembly 130. The cross-sectional view of FIG. 3a is taken in the same plane as the view of FIG. 1, whilst the cross-sectional view of FIG. 3b is taken along the plane A-A shown in FIG. 3a, which is normal to the axis 103. In the embodiment shown, the pawl assembly includes six pawls 132a-f. However, the pawl assembly 130 may include a different number of pawls in other embodiments. The pawl assembly 130 is located within the central shaft 108, at least a portion of which may be formed of a hollow tube. Each of the pawls 132a-f is configured to engage the ratchet 126 when the nut 106 is engaged with the threaded surface 116 of the hub 104. The central shaft 108 of the hub 104 includes a series of apertures through which the pawls 132a-f are arranged to protrude to engage the ratchet 106. In particular, as shown in FIG. 4a, each pawl 132a-f includes a body portion 134 which is located within the central shaft 108, and a finger 136 which is arranged to protrude through a corresponding aperture in the central shaft 108. A pawl 132 of the pawl assembly 130 is shown on its own in FIGS. 4a-4c, with FIG. 4a showing a side view of the pawl 132, FIG. 4b showing a top view of the pawl 132, and FIG. 4c showing a cross-sectional side view of the pawl 132. The cross-sectional view of FIG. 4c is taken along the plane C-C shown in FIG. 4a. The body portion 134 of each pawl 132a-f includes a lip 138 which is larger than the corresponding aperture in the central shaft 108, to prevent the pawl 132a-f from falling out of the central shaft 108. The pawl assembly 130 is located towards an outer end of the central shaft 108 of the hub 104, such that the threaded surface 116 is located between the pawl assembly 130 and the plate 112 (along a direction of the axis 103).

The pawl assembly 130 further includes a pawl housing 140 which is mounted inside the central shaft 108 of the hub 104. Each pawl 132a-f is received in a respective channel 142 defined in the pawl housing 140. For example, the pawl housing 140 may include a body (e.g. made of a piece of material) having a respective channel 142 formed therein for each of the pawls 132a-f. In the embodiment shown, a splined connection 144 is formed between the pawl housing 140 and the central shaft 108 of the hub 104, so that the pawl housing 140 and the hub 104 are rotationally locked to one another, i.e. so that they rotate together about the axis 103 as one. For example, a female spline on an inner surface of the central shaft 108 may be engaged with a male spline on an outer surface of the pawl housing 140 (or vice versa). The pawl housing 140 may further be secured to the hub via a set of bolts 141, as shown in FIG. 3b. For example, the bolts 141 may be engaged with an internal part located inside the central shaft 108 such that the pawl housing 140 is held against the internal part, the internal part abutting against a shoulder inside the central shaft 108. In other embodiments, the pawl housing 140 may be formed integrally as part of the hub 104.

Each respective channel 142 extends in a respective radial direction relative to the axis 103 of the hub 104 (i.e. in a direction normal to the axis 103), and is arranged to guide motion of the pawl 132a-f disposed therein along the radial direction. In particular, each pawl 132a-f is movable along its respective channel between an extended state in which its finger 136 protrudes from the central shaft 108, and a retracted state in which its finger 136 does not protrude (or protrudes to a lesser extent) from the central shaft 108. Each respective channel 142 may have a cross-sectional shape that substantially matches a cross-sectional shape of the body portion 134 of the pawl 132a-f disposed therein, such that motion of the pawl 132a-f is restricted to the radial direction defined by the channel 142. A biasing element in the form of a spring (e.g. coil spring) 146 is located in each respective channel 142, and extends between an end of the channel 142 and the pawl 132a-f of that channel 142, in order to urge the pawl 132a-f towards its extended state. As shown in FIG. 4c, each pawl 132a-f includes a cavity 135 formed in its body portion 134, the cavity being arranged to receive an end of the spring 146.

Moreover, the pawls 132a-f are arranged into three pairs: a first pair including pawls 132a and 132d, a second pair including pawls 132b and 132e, and a third pair including pawls 132c and 132f. The pawls in each pair extend in radially opposite directions with respect to the axis 103 of the hub 104, such that the pawls in each pair are arranged to engage the ratchet 126 at positions which are diametrically opposed relative to the axis 103.

The pawls 132a-f are configured to engage the ratchet 126 when the nut 106 is engaged with the threaded surface 116 on the central shaft 108 of the hub 104. In particular, the finger 136 of each pawl 132a-f engages the ratchet 126 when the nut 106 is engaged with the threaded surface 116. The engagement between the pawls 132a-f and the ratchet is such that it allows rotation of the nut 106 about the axis 103 in the first (tightening) direction, but blocks rotation of the nut 106 about the axis 103 in the second (loosening) direction. This is achieved by the shapes of the ratchet teeth 126 and the pawls 132a-f, whereby the ratchet teeth 126 can slide over the pawls 132a-f when the nut is rotated in the first direction, but such that one or more of the pawls 132a-f blockingly abuts a ratchet tooth 128 when a torque is applied to the nut 106 in the second direction.

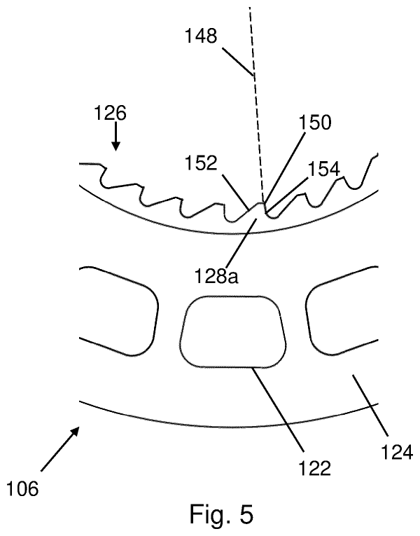

An example shape of the ratchet teeth 128 is described in more detail in relation to FIG. 5, which shows an expanded view of a portion of the external-facing side of the nut 106. Each tooth 128 of the ratchet has a shape which is asymmetrical with respect to a radius of the circular arrangement of teeth 128, the radius linking a centre of the circular arrangement and a tip of that tooth 128. This is illustrated in FIG. 5, where the radius 148 extends from the centre (not shown in FIG. 5) of the circular arrangement to the tip 150 of a tooth 128a. As can be seen, the tooth 128a is asymmetrical with respect to the radius 148. In more detail, the tooth 128a has a first tooth surface 152 disposed on a first side of the radius 148, and a second tooth surface 154 disposed on a second side of the radius 148, the first tooth surface 152 and the second tooth surface 154 being asymmetrical with respect to the radius 148, i.e. the first and second tooth surfaces 152, 154 are not mirror images of one another with respect to the radius 148. As shown in FIG. 5, the second tooth surface 154 may be aligned with the radius 148, such that the second tooth surface 154 may extend in a direction normal to a tangent of the circular arrangement of teeth 128 at the location of the tip 150. On the other hand, the first tooth surface 152 is slanted relative to the radius 148. The tip 150 of the tooth 128a corresponds to a point of the tooth 128a where the first tooth surface 152 and the second tooth surface 154 meet. The tip 150 may be slightly rounded, e.g. such that the tooth 128a has a rounded edge located between the first and second tooth surfaces 152, 154. Each tooth 128 in the ratchet 126 has the same shape as the tooth 128a described above.

As shown in FIG. 4c, the finger 136 of each pawl 132a-f has a first pawl surface 156 and a second pawl surface 158. As noted above, each of the pawls 132a-f is located in a respective channel that extends in a respective radial direction with respect to the axis 103 of the hub 104, i.e. each of the pawls 132a-f extends in a respective radial direction with respect to the axis 103. FIG. 4c depicts a corresponding radial direction 160 for the depicted pawl 132. The first pawl surface 156 and the second pawl surface 158 are asymmetrical about the radial direction 160. In particular, the second pawl surface 158 extends in a direction substantially parallel to the radial direction 160, whilst the first pawl surface 156 is slanted relative to the radial direction 160. Each of the pawls 132a-f has first and second pawl surfaces 156, 158 as shown in FIG. 4c.

When the nut 106 is screwed on to the hub 104 (i.e. when the nut 106 is engaged with the threaded surface 116), the first pawl surface 156 of each pawl 132a-f is configured to contact and slide over the first tooth surfaces 152 of teeth 128 in the ratchet 126. In particular, the slanting of the first pawl surfaces 156 and the first tooth surfaces 152 discussed above enables the pawls 132a-f to slide over the ratchet teeth 128 without blocking rotation of the nut 106 in the first direction. As each pawl 132a-f slides over a tooth 128 in the ratchet 126, the pawl 132a-f is caused to retract into its channel 142 due to the profile of the tooth 128. After passing over the tooth 128, the pawl 132a-f then extends back out of its channel 142, under action of the spring 146. On the other hand, if when the nut 106 is engaged with the threaded surface 116, a torque is applied to the nut 106 in the second direction, the second pawl surface 158 of at least one of the pawls 132a-f will abut against the second tooth surface 154 of one of the ratchet teeth 128. As the second pawl surface 158 and the second tooth surface 154 are aligned along a radial direction, they are substantially normal to rotational motion of the nut 106 about the axis 103 of the hub 104. As a result, abutment of the second pawl surface 158 against the second tooth surface 154 blocks further rotation of the nut 106 in the second direction. This prevents loosening of the nut 106 on the hub 104 once it has been screwed on to the hub 104. Engagement between the pawls 132a-f and the ratchet 126 is maintained by the springs 146, which urge the pawls 132a-f radially outwards (i.e. away from the axis 103) towards the ratchet 126. Additionally, when the wheel 102 rotates about the axis 103, centrifugal forces act to further urge the pawls 132a-f radially outwards and into contact with the ratchet 126.

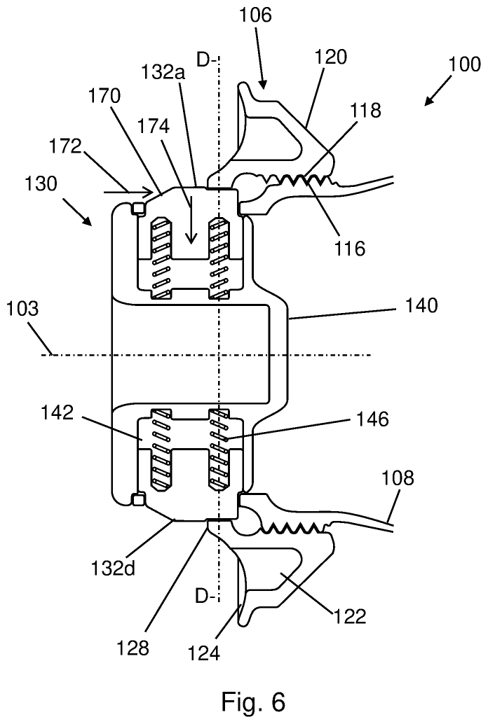

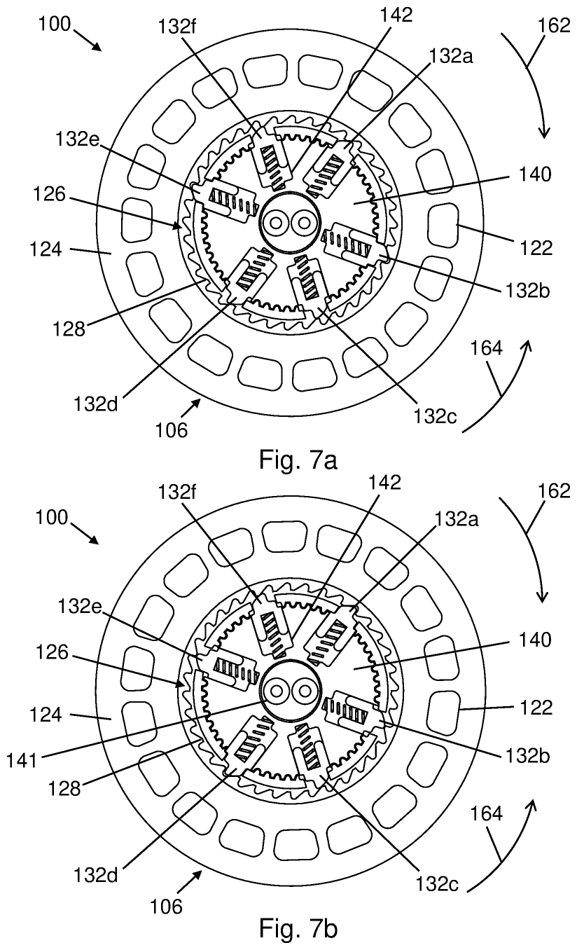

FIGS. 6 and 7a-7b show views of the wheel fastening system 100 when the nut 106 is engaged with the threaded surface 116 on the hub 104. FIG. 6 shows a close-up cross-sectional view of the wheel fastening system 100 when the nut 106 is engaged with the threaded surface 116 on the central shaft 108 of the hub 104, the cross-sectional view of FIG. 6 being taken along the same plane as that of FIG. 1 and FIG. 3a. FIGS. 7a and 7b show front views of the wheel fastening system 100, with a cross-section taken along plane D-D (shown in FIG. 6) for illustration purposes. The views of FIGS. 7a and 7b show the wheel fastening system 100 with the nut 106 is in different rotational positions. As shown in FIG. 6, when the nut 106 is engaged with the threaded surface 116 on the hub 104, the pawls 132a-f in the pawl assembly 130 engage the ratchet 126. In FIGS. 7a-7b, the first direction of rotation of the nut 106 about the axis 103 is indicated by reference numeral 162, whilst the second direction of rotation of the nut 106 about the axis 103 is indicated by reference numeral 164.

Due to the arrangement of the pawls 132a-f in pairs which extend in radially opposing directions, two of the pawls 132a-f may be simultaneously engaged with teeth 128 in the ratchet 126 to block rotation of the nut 106 in the second direction. For example, in the configuration shown in FIG. 7a, the pawls 132b and 132e in the second pair are engaged with respective teeth 128 of the ratchet 126 so as to block rotation of the nut 106 in the second direction 164. In particular, in FIG. 7a the second pawl surfaces 158 of pawls 132b and 132e are engaged with second tooth surfaces 154 of respective ratchet teeth 128, thereby blocking rotation of the nut 106 in the second direction 164. As a result, if a torque is applied to the nut 106 in the second direction 164, then both of the pawls 132b and 132e will react against the torque, to prevent the nut 106 from rotating. In this manner, forces experienced by the pawl assembly 130 in response to the torque applied to the nut 106 in the second direction 164 are distributed about the axis 103. On the other hand, in line with the discussion above, if a torque in the first direction 162 is applied to the nut 106 in the configuration of FIG. 7a, then rotation of the nut 106 is not blocked by engagement of the pawls 132a-f with the ratchet. Accordingly, the torque in the first direction 162 may cause the nut 106 to rotate in the first direction 162, with the first pawl surfaces 156 of the pawls 132a-f sliding over the first tooth surfaces 152 of the ratchet teeth 128. In the configuration of FIG. 7a, the pawls 132c and 132f in the third pair are maximally retracted within their respective channels 142, as they are contacting tips 150 of teeth 128 in the ratchet 126. The pawls 132a and 132d in the first pair are partially retracted within their respective channels 142, as they are contacting first tooth surfaces 152 of teeth 128 in the ratchet 126.

In the embodiment shown, the pawls 132a-f and the ratchet 126 are arranged such that only the pawls in one of the three pairs can engage second tooth surfaces 154 in the ratchet 126 at any one time. Thus, as shown in FIG. 7a, whilst the pawls 132b and 132e are engaged with second tooth surfaces 154 of respective ratchet teeth 128, the remaining pawls 132a, 132c, 132d and 132f are not engaged with second tooth surfaces 154. Rather, the remaining pawls 132a, 132c, 132d and 132f are engaged with respective first tooth surfaces 152 in the ratchet 126, at various intermediate positions between the second tooth surfaces 154 of adjacent ratchet teeth 128. As a result, in the configuration of FIG. 7a, only the pawls 132b and 132e act to block rotation of the nut 106 in the second direction 164, as they are the only ones engaged with second tooth surfaces 154. This is achieved by arranging a first angular spacing 166 (shown in FIG. 2a) between adjacent teeth 128 of the ratchet 126 so that it is not a factor of second angular spacings 168 (shown in FIG. 3b) between adjacent pawls 132a-f in the pawl assembly 130.

In the embodiment shown, the ratchet 126 has thirty-six evenly spaced teeth 128, such that there is a first angular spacing 166 of 10° between adjacent teeth 128 in the ratchet 126. Of course, in other embodiments, the ratchet 126 may include a different number of teeth 128 with a different angular spacing 166. The first angular spacing 166 is measured relative to a centre of the circular arrangement of ratchet teeth 128 (which corresponds to the axis 103 when the nut 106 is engaged with the threaded surface 116). In particular, as shown in FIG. 2a, the first angular spacing 166 corresponds to an angle between a first radius linking the centre of the circular arrangement of ratchet teeth 128 with the tip of a first tooth and a second radius linking the centre of the circular arrangement of ratchet teeth 128 with the tip of a second, adjacent tooth.

The second angular spacing 168 shown in FIG. 3b corresponds to an angular spacing between the pawl 132e and the pawl 132f. The second angular spacing 168 is defined relative to a circle centred at the axis 103 of the hub 104 and located in a plane normal to the axis 103 of the hub 104. In particular, as shown in FIG. 3b, the second angular spacing 168 corresponds to an angle swept by a radius centred at the axis 103, between a first radial direction of the pawl 132e and a second radial direction of the pawl 132f. The first radial direction of the pawl 132e may extend from the axis 103 through a centre of the pawl 132e, whilst the second radial direction of the pawl 132f may extend from the axis 103 through a centre of the pawl 132f. Second angular spacings 168 between other pairs of adjacent pawls in the pawl assembly 130 may be defined in a similar manner, i.e. based on the angular difference between the radial directions of the relevant pawls. In the embodiment shown, the second angular spacing 168 between pawls 132e and 132f are substantially the same as a second angular spacing between pawls 132f and 132a. As the pawls 132a-f are arranged into pairs that extend in radially opposing directions, the second angular spacing between pawls 132c and 132d and the second angular spacing between pawls 132b and 132c are substantially the same as the second angular spacing 168 shown in FIG. 3b. In other words, the second angular spacing 168 corresponds to an angular spacing between the third pair of pawls 132c, 132f and the second pair of pawls 132b, 132e, as well as an angular spacing between the third pair of pawls 132c, 132f and the first pair of pawls 132a, 132d.

As noted above, the first angular spacing 166 between adjacent teeth 128 of the ratchet 126 is not a factor of second angular spacings 168 between adjacent pawls 132a-f in the pawl assembly 130. Thus, in the embodiment shown, where the first angular spacing 166 is 10°, the second angular spacings 168 are not multiples of 10°. In the embodiment shown, the second angular spacing 168 is set such that it is a multiple of a third (⅓) of the first angular spacing 166. More generally, the relationship between the first and second angular spacings 166, 168 may be selected based on the number and arrangement of pawls in the pawl assembly, to ensure that no angular spacing between any two pawls in different pairs is a multiple of the first angular spacing 166. As an example, where the pawl assembly 130 includes n pairs of pawls extending in radially opposite directions (n being a real number), a second angular spacing 168 between adjacent pawls may be a multiple of 1/n times the first angular spacing 166, where the multiple of 1/n is not itself a multiple of n.

The described arrangement of the first and second angular spacings 166, 168 serves to reduce an amount by which the nut 106 can be rotated if a slippage occurs between the pawls 132a-f and the ratchet 126. For example, starting from the configuration shown in FIG. 7a, if the engagement between the pawls 132b and 132e and the ratchet 126 slips (e.g. due to failure of a ratchet tooth 128 and/or the pawls 132b and 132e), then the nut 106 may rotate in the second direction 164 until the pawls 132a and 132d in the first pair engage second tooth surfaces 154 in the ratchet 126, as shown in FIG. 7b, to block further rotation of the nut 106 in the second direction 164. The amount of rotation of the nut 106 required to reach the configuration shown in FIG. 7b, starting from the configuration shown in FIG. 7a, is less than the first angular spacing 166 between adjacent ratchet teeth 128. In particular, the amount of rotation of the nut 106 is only a third of the first angular spacing 166. This is because, in the configuration of FIG. 7a, the pawls 132a and 132d are located at an intermediate position between second tooth surfaces 154 of adjacent teeth 128, such that the nut 106 can only be rotated a fraction of the first angular spacing 166 before the pawls 132a and 132d engage second tooth surfaces 154 in the ratchet 126. Likewise, starting from the configuration shown in FIG. 7b, if there is a slippage between the pawls 132a and 132d and the ratchet 126, then the next pawls to blockingly engage second tooth surfaces 154 in the ratchet 126 will be the pawls 132c and 132f, corresponding to a rotation of the nut 106 by only one third of the first angular spacing 166. Accordingly, if there is a failure in the engagement between the pawl assembly 130 and the ratchet 126, the nut 106 can only be loosened by an amount less than the first angular spacing 166.

As discussed above, once the nut 106 is screwed onto the hub 104, the nut 106 is prevented from being loosened (i.e. unscrewed). To enable the nut 106 to be removed (e.g. to enable removal or replacement of the wheel 102), each pawl 132a-f is provided with a tool receiving portion 170 (shown in FIG. 4a), which is configured to receive a disengaging force from a tool. The tool receiving portion 170 is located at an opposing end of the pawl 132a-f from the finger 136 in a direction parallel to the axis 103 of the hub 104, and includes a slanted surface which is arranged to slant towards the axis 103 of the hub 104. The tool receiving portion 170 faces outwards from the hub 104, i.e. so that it faces away from the wheel 102 when the wheel 102 is mounted on the hub 104. Additionally, the tool receiving portion 170 of each pawl 132a-f is arranged to remain exposed when the nut 106 is engaged with the threaded surface 116 as shown in FIG. 6, so that it can easily be accessed by a user. In order to disengage a pawl 132a-f from the ratchet 126, a disengaging force may be applied to the tool receiving portion 170 to cause the pawl to retract within its channel 142, so that it no longer engages the ratchet 126 and thus cannot block rotation of the nut 106 in the second direction. In particular, as shown in FIG. 6, the slanted surface of the tool receiving portion 170 acts to convert a disengaging force (indicated by arrow 172) applied longitudinally along the axis 103 into a radial motion (indicated by arrow 174) of the pawl toward the axis 103, causing the pawl to retract within its respective channel 142. The disengaging force applied to the tool receiving portion 170 must be sufficient to overcome a biasing force exerted by the spring 146 of the pawl, to cause the pawl to be retracted into its channel 142. Accordingly, if a disengaging force is applied simultaneously to the tool receiving portion 170 of each pawl 132a-f in the pawl assembly 130, then the pawls 132a-f can all be disengaged from the ratchet 126, to thereby allow rotation of the nut 106 in the second direction. Then, maintaining the disengaging force on the pawls 132a-f, the nut 106 can be rotated in the second direction, to remove it from the hub 104, e.g. to enable the wheel 102 to be removed from the hub 104. A specially designed tool (not shown) may be used for simultaneously applying a disengaging force to the tool engaging portion 170 of each of the pawls 132a-f. For example, the tool may include plurality of protrusions which are arranged to enable each protrusion to engage the tool receiving portion of a respective pawl 132a-f.

In the above, a specific embodiment of the invention is discussed with respect to the drawings. However, it will be appreciated that various modifications may be made to the embodiment, without departing from the scope of the invention. For example, although in the described embodiment the pawl assembly is shown as being located on the hub whilst the ratchet is shown as being located on the nut, in other embodiments the pawl assembly may be located on the nut whilst the ratchet may be located on the hub. As another example, although in the embodiment shown the hub comprises a male thread (threaded surface 116) and the nut comprises a female thread (threaded inner surface 118), in other embodiments the hub may comprise a female thread whilst the nut may comprise a male thread.

1. A wheel fastening system for a vehicle, the wheel fastening system comprising:
a hub on which a wheel is mountable, the hub comprising a threaded surface;
a nut which is engageable with the threaded surface to fasten the wheel to the hub, wherein, when the nut is engaged with the threaded surface, rotation of the nut in a first direction about an axis of the hub results in tightening of the nut on the hub;
a pawl assembly arranged on a first one of the hub and the nut, the pawl assembly comprising one or more pawls; and
a ratchet arranged on a second one of the hub and the nut;
wherein, when the nut is engaged with the threaded surface, each of the one or more pawls is configured to engage with the ratchet to thereby allow rotation of the nut about the axis in the first direction and block rotation of the nut about the axis in a second, opposite direction.

2. The wheel fastening system according to claim 1, wherein:
the pawl assembly is disposed on the hub, and the ratchet is disposed on the nut, or
each of the one or more pawls is configured to protrude through an aperture in the hub to engage with the ratchet.

3. (canceled)

4. The wheel fastening system according to claim 1, wherein the pawl assembly comprises two or more pawls.

5. The wheel fastening system according to claim 4, wherein the two or more pawls comprise a pair of pawls which are arranged to extend radially relative to the axis of the hub when the nut is engaged with the threaded surface on the hub.

6. The wheel fastening system according to claim 4, wherein the pair of pawls are arranged to extend in opposite directions relative to the axis of the hub when the nut is engaged with the threaded surface on the hub.

7. The wheel fastening system according to claim 4, wherein the pair of pawls are arranged to extend away from the axis of the hub when the nut is engaged with the threaded surface on the hub.

8. The wheel fastening system according to claim 4, wherein:
the ratchet comprises a plurality of evenly spaced teeth disposed in a circular arrangement; and
the two or more pawls comprise a first pawl and a second pawl, the first pawl and the second pawl being arranged such that a first angular spacing between adjacent teeth in the ratchet is not a factor of a second angular spacing between the first pawl and the second pawl, the first angular spacing and the second angular spacing being relative to a circle centred at the axis of the hub when the nut is engaged with the threaded surface on the hub.

9. The wheel fastening system according to claim 1, wherein the pawl assembly further comprises a biasing element configured to urge the one or more pawls into engagement with the ratchet when the nut is engaged with the threaded surface on the hub.

10. The wheel fastening system according to claim 1, wherein:
the pawl assembly further comprises a pawl housing; and
each of the one or more pawls is received in a respective channel formed in the pawl housing, the channel being configured to guide movement of the pawl in a radial direction relative to the axis of the hub when the nut is rotated about the axis of the hub.

11. The wheel fastening system according to claim 10, wherein the pawl assembly is disposed on the hub, and the ratchet is disposed on the nut wherein:
the pawl housing is mounted in the hub; and
the pawl housing comprises a rotational locking feature that is engaged with a corresponding rotational locking feature on the hub, such that the pawl housing and hub are configured to rotate together about the axis of the hub.

12. The wheel fastening system according to claim 1, wherein each of the one or more pawls is configured to be disengageable from the ratchet when the nut is engaged with the threaded surface on the hub.

13. The wheel fastening system according to claim 1, wherein each of the one or more pawls includes a ratchet engaging portion configured to engage the ratchet, and a tool receiving portion configured to receive a disengaging force from a tool, the pawl being configured to disengage from the ratchet in response to application of the disengaging force to the tool receiving portion.

14. The wheel fastening system according to claim 13, wherein:
the tool receiving portion comprises a slanted surface that slants towards the axis of the hub; and
the pawl is configured to move radially relative to the axis of the hub in response to a disengaging force applied to the slanted surface along a direction parallel to the axis of the hub.

15. The wheel fastening system according to claim 1, wherein:
the ratchet comprises a plurality of evenly spaced teeth disposed in a circular arrangement, each tooth of the ratchet having a first tooth surface and a second tooth surface;
each of the one or more pawls has a first pawl surface that is configured to contact and slide over the first tooth surface of one of the teeth when the nut is engaged with the threaded surface and the nut is rotated about the axis of the hub in the first direction; and
each of the one or more pawls has a second pawl surface that is engageable with the second tooth surface of one of the teeth when the nut is engaged with the threaded surface, whereby engagement of the second pawl surface of one of the one or more pawls with the second tooth surface of one of the teeth blocks rotation of the nut about the axis of the hub in the second direction.

16. The wheel fastening system according to claim 15 wherein, for each tooth of the ratchet, the first tooth surface and the second tooth surface are shaped such that the tooth is asymmetrical about a radius of the circular arrangement extending through a tip of the tooth.

17. The wheel fastening system according to claim 16 wherein, for each tooth of the ratchet, the second tooth surface is aligned along a respective radial direction of the circular arrangement, and the first tooth surface is slanted relative to the respective radial direction.

18. The wheel fastening system according to claim 15, wherein:
each of the one or more pawls is arranged to extend along a respective radial axis that is normal to the axis of the hub when the nut is engaged with the threaded surface; and
for each of the one or more pawls, the first pawl surface and the second pawl surface are shaped such that the pawl is asymmetrical about its respective radial axis.

19. The wheel fastening system according to claim 18, wherein, the first pawl surface of each of the one or more pawls is aligned parallel to its respective radial axis, and the second pawl surface of each of the one or more pawls is slanted relative to its respective radial axis.

20. The wheel fastening system according to claim 1, wherein the nut comprises an outer face having a plurality of tool engagement features arranged around a central axis of the nut for applying a torque to the nut about its central axis.

21. A vehicle comprising a wheel fastening system according to claim 1.
